(19) United States
(12) Patent Application Publication
(10) Pub. No.: US 2015/0266364 A1
(43) Pub. Date: Sep. 24, 2015

(54) ENGAGEMENT STRUCTURE OF DOOR EQUIPPED ON VEHICLE

(71) Applicant: Hyundai Motor Company, Seoul (KR)

(72) Inventors: Sang Young IM, Seoul (KR); Eui Chan CHO, Suwon-si (KR)

(73) Assignee: Hyundai Motor Company, Seoul (KR)

(21) Appl. No.: 14/301,096

(22) Filed: Jun. 10, 2014

(30) Foreign Application Priority Data
Mar. 20, 2014 (KR) 10-2014-0032653

(51) Int. Cl. B60J 10/00; B60J 10/08

(52) U.S. Cl. CPC B60J 10/0017; B60J 10/08; B60J 10/0062; B60J 10/0054

(57) ABSTRACT

An engagement structure of a door may include an outer frame having an end portion bent portion and a middle bent portion, an inner panel where a first end portion thereof is inserted into a gap between the end bent portion and a second end portion thereof is joined to a second end portion of the outer frame through a welding engagement portion, a space having a gap from the outer frame to the inner panel between the middle bent portion and the welding engagement portion, and a molding that covers an outside surface between the middle bent portion and the end bent portion, and a round engagement portion formed to cover a rounded portions of the end bent portion and the middle bent portion.

### CROSS-REFERENCE TO RELATED APPLICATION

This application claims priority to Korean Patent Application No. 10-2014-0032653 filed Mar. 20, 2014, the entire contents of which is incorporated herein for all purposes by this reference.

### BACKGROUND OF THE INVENTION

1. Field of the Invention

The present invention is related to an engagement structure of a door equipped on a vehicle that combines merits of a frame door and an invisible panel door to secure high level of external appearance, stiffness, and assembly easiness.

2. Description of Related Art

A frame door has a structure that the section of the roof side thereof is formed by a rolling forming and is exposed to an outside without a molding, and therefore the quality of the external appearance can be deteriorated over time.

An invisible panel door has a structure that is not exposed to an outside, a sealing member and a molding is added thereto, the external appearance level is high by the molding, but the assembly structure, the molding and the panel can be weak.

Accordingly, researches for improving the quality of the appearance of the door, simultaneously with assembly easiness, and the stiffness are being progressed.

Through the researches, the sensitivity of the consumer is satisfied, the production cost is reduced, and the stiffness is secured such that overall stability of the vehicle is improved.

As a conventional art, there is a Japanese application No. 2002-242619.

The information disclosed in this Background section is only for enhancement of understanding of understanding of the general background of the invention and should not be taken as an acknowledgement or any form of suggestion that this information forms the prior art already known to a person skilled in the art.

### BRIEF SUMMARY

Various aspects of the present invention are directed to providing an engagement structure of a door equipped on a vehicle having advantages of improving the quality of the external appearance, securing the stiffness, and simultaneously enhancing the assembly easiness such that the sensitivity of the consumer can be satisfied and the stability of the vehicle be improved.

In an aspect of the present invention, an engagement structure of a door that is equipped on a vehicle, may include an outer frame having an end bent portion, wherein a first end portion of the outer frame is bent to form the end bent portion, and a middle bent portion, wherein a middle portion between the first end portion and a second end portion of the outer frame is bent to form the middle bent portion, an inner panel including a first end portion being inserted into a first gap formed in the end bent portion to be fixed thereto, and a second end portion being coupled to the second end portion of the outer frame through a welding engagement portion, wherein a predetermined space is formed between an inner surface of the inner panel and an inner surface of the outer panel and may include a second gap from the inner surface of the outer frame to the inner surface of the inner panel between the middle bent portion and the welding engagement portion, and a molding that covers an outside surface between the middle bent portion and the end bent portion, the molding bent portion including round engagement portions formed at a first end and a second end thereof to cover rounded portions of the end bent portion and the middle bent portion respectively.

The engagement structure may include a third gap formed between the middle bent portion and the welding engagement portion of the outer frame to receive a door glass therein, and a sealing member that is respectively positioned on the outer frame, the inner frame, and a vehicle body to form a sealing structure, wherein the vehicle body is positioned with a predetermined distance from the inner panel.

The middle bent portion and the end bent portion are bent.

The middle bent portion and the end bent portion are bent 180 degrees, each of the middle bent portion and the end bent portion forming the one portion that is bent into two sections that face each other.

The second gap may include a fourth gap formed between the outer frame and the inner panel in a direction that the door glass moves, and a fifth gap formed to be perpendicular to the fourth gap between the outer frame and the inner panel.

The fifth gap is longer than the fourth gap.

The sealing member may include a first sealing member that is engaged with the outer frame between the middle bent portion and the welding engagement portion to form a sealing structure between the door glass and the outer frame, a second sealing member that is engaged with the inner panel to form a sealing structure between the inner panel and the vehicle body, and a third sealing member that is engaged with the vehicle body to form a sealing structure between the inner panel and the vehicle body.

The welding engagement portion is formed at a part that a surface of the outer frame contacts a surface of the inner panel by a predetermined length.

The molding is positioned to cover an outside surface between the middle bent portion and the end bent portion of the outer frame.

The welding engagement portion is formed at an inner side of the vehicle body based on the molding.

In accordance with the present invention for realizing the object, a predetermined space is formed between the inner panel and the outer frame to be able to improve the stability of the vehicle body.

Also, the molding is securely engaged with a part that is exposed to an outside on an outer frame such that the quality of the external appearance is improved and simultaneously the productivity and the assembly easiness are improved.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an engagement structure of a door equipped on a vehicle according to an exemplary embodiment of the present invention.

Reference numerals set forth in the Drawings include reference to the following elements as further discussed below:

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described with reference to the accompanying drawings so that those skilled in the Field of the Invention to which the present invention pertains may carry out the exemplary embodiment.

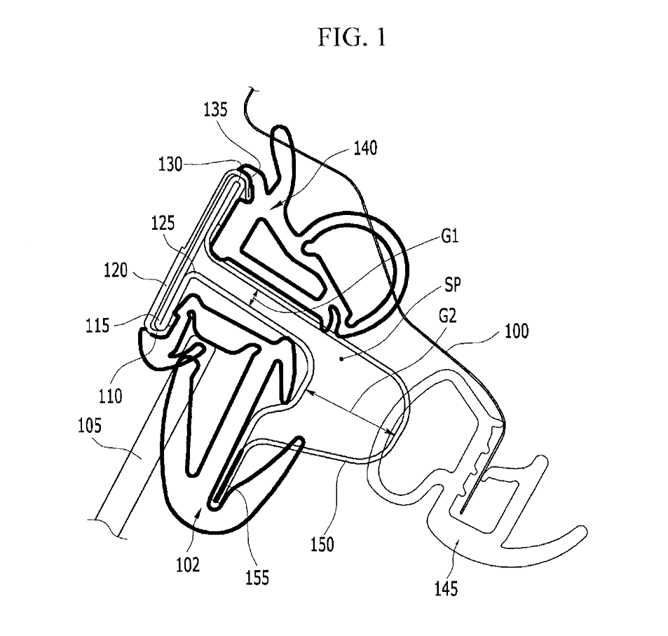

FIG. 1 is a schematic diagram of an engagement structure of a door equipped on a vehicle according to an exemplary embodiment of the present invention.

Referring to FIG. 1, an engagement structure of a door equipped on a vehicle may include a vehicle body 100, an outer frame 125, an inner panel 150, a molding 120, a first sealing member 102, a second sealing member 140, a third sealing member 145, and a door glass 105.

An end bent portion 130 that is bent 180 degrees, so that it forms one portion that is bent into two sections that face each other, may be formed at a first end portion of the outer frame 125, and a welding engagement portion 155 that is welded on the inner panel 150 may be formed at a second end portion of the outer frame 125.

In an exemplary embodiment of the present invention, the welding engagement portion 155 can be formed by a spot welding, laser welding or any similar metal fusion/welding process. Further, a middle bent portion 115 that is bent 180 degrees, so that it forms one portion that is bent into two sections that face each other, is formed between the end bent portion 130 and the welding engagement portion 155.

A first end portion of the inner panel 150 may be inserted into a gap that is formed between the end bent portion 130. A second end portion of the inner panel 150 may be welded on a surface of the outer frame 125 to be fixed. The second end portion of the inner panel 150 may be welded on the surface of the outer frame 125 by spot welding, laser welding or any similar metal fusion/welding process.

In one aspect of the present invention, a predetermined gap is formed between the portions of inner panel 150 and outer frame 125 that face each other, a predetermined space SP is formed between the middle bent portion 115 and the welding engagement portion 155, bordered by the inner panel 150. The space SP is formed by a first gap G1 and a second gap G2, the second gap G2 being longer than the first gap G1.

The molding 120 is engaged to cover an outside surface of the outer frame 125 between the end bent portion 130 and the middle bent portion 115. A second round engagement portion 135 and a first round engagement portion 110 are respectively formed at a first end portion and a second end portion of the molding 120.

The second round engagement portion 135 covers a rounded outer portion of the end bent portion 130, and the first round engagement portion 110 covers a rounded outer portion of the middle bent portion 115.

In another aspect of the present invention, a vehicle body 100 is positioned at a predetermined gap from an outside surface of the inner panel 150, and a second sealing member 140 is interposed between the inner panel 150 and the vehicle body 100. The door glass is positioned to be inserted into a gap between the middle bent portion 115 and the welding engagement portion 155 of the outer frame. A first sealing member 102 is positioned at an area between the middle bent portion 115 and the welding engagement portion 155 on the outer frame 125, and the first sealing member 102 forms a sealing structure with the door glass 105.

A third sealing member 145 that is fixed to the vehicle body 100 contacts a convex part that is formed by the inner panel 150 to form a sealing structure.

The part that is exposed to outside conditions on the outer frame 125 is covered by the molding 120, and the molding 120 can thus secure the quality of the external appearance.

The molding 120 is fixed on the outer frame 125 through the first round engagement portion 110 and the second round engagement portion 135 to be able to improve the productivity and assembly easiness.

Further, the outer frame 125 and the inner panel 150 are securely assembled through the end bent portion 130 and the welding engagement portion 155 and can secure a structural stiffness through a predetermined gap that is formed between the outer frame 125 and the inner panel 150.

In an exemplary embodiment of the present invention, the inner panel 150 can be manufactured by a press forming, the outer frame 125 can be formed by a roll forming, and the inner panel 150 and the outer frame 125 that are formed as described are combined to a box shape section through the second gap G2.

Overall stiffness can be improved through the space that is formed by the first gap G1 and the box shape section that is formed by the second gap G2.

An inner side of the outer frame 125 and the inner panel 150 are coupled by the welding engagement portion 155 and an outer side of the outer frame 125 is coupled to the inner panel by a hemming engagement in which the end bent portion 130 presses the inner panel 150.

In another aspect of the present invention, the outer frame 125 cannot be exposed to an outside depending on the option of the molding 120.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engagement structure of a door that is equipped on a vehicle, comprising:
an outer frame including:
an end bent portion, wherein a first end portion of the outer frame is bent to form the end bent portion; and
a middle bent portion, wherein a middle portion between the first end portion and a second end portion of the outer frame is bent to form the middle bent portion;
an inner panel including:
a first end portion being inserted into a first gap formed in the end bent portion to be fixed thereto; and
a second end portion being coupled to the second end portion of the outer frame through a welding engagement portion,
wherein a predetermined space is formed between an inner surface of the inner panel and an inner surface of the outer panel and includes a second gap from the inner surface of the outer frame to the inner surface of the inner panel between the middle bent portion and the welding engagement portion; and
a molding that covers an outside surface between the middle bent portion and the end bent portion, the molding bent portion including round engagement portions formed at a first end and a second end thereof to cover rounded portions of the end bent portion and the middle bent portion respectively.

2. The engagement structure of claim 1, comprising:
a third gap formed between the middle bent portion and the welding engagement portion of the outer frame to receive a door glass therein; and
a sealing member that is respectively positioned on the outer frame, the inner frame, and a vehicle body to form a sealing structure, wherein the vehicle body is positioned with a predetermined distance from the inner panel.

3. The engagement structure of claim 2, wherein the middle bent portion and the end bent portion are bent.

4. The engagement structure of claim 3, wherein the middle bent portion and the end bent portion are bent 180 degrees, each of the middle bent portion and the end bent portion forming the one portion that is bent into two sections that face each other.

5. The engagement structure of claim 2, wherein the second gap includes:
a fourth gap formed between the outer frame and the inner panel in a direction that the door glass moves, and
a fifth gap formed to be perpendicular to the fourth gap between the outer frame and the inner panel.

6. The engagement structure of claim 5, wherein the fifth gap is longer than the fourth gap.

7. The engagement structure of claim 2, wherein the sealing member includes:
a first sealing member that is engaged with the outer frame between the middle bent portion and the welding engagement portion to form a sealing structure between the door glass and the outer frame;
a second sealing member that is engaged with the inner panel to form a sealing structure between the inner panel and the vehicle body; and
a third sealing member that is engaged with the vehicle body to form a sealing structure between the inner panel and the vehicle body.

8. The engagement structure of claim 2, wherein the welding engagement portion is formed at a part that a surface of the outer frame contacts a surface of the inner panel by a predetermined length.

9. The engagement structure of claim 2, wherein the molding is positioned to cover an outside surface between the middle bent portion and the end bent portion of the outer frame.

10. The engagement structure of claim 9, wherein the welding engagement portion is formed at an inner side of the vehicle body based on the molding.
